(19) United States
(12) Patent Application Publication
(10) Pub. No.: US 2009/0039134 A1
(43) Pub. Date: Feb. 12, 2009

(54) Driving Tool

(76) Inventor: Kouji Kubo, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/920,723

(22) PCT Filed: May 22, 2006
(86) PCT No.: PCT/JP2006/310158

§ 371 Date: Nov. 20, 2007

(30) Foreign Application Priority Data
May 25, 2005 (JP) 2005-152035

(51) Int. Cl. B25C 7/00

(52) U.S. Cl. 227/120

(57) ABSTRACT

A driving tool is provided with a magazine 5, a striking mechanism for driving out a fastener, a contact mechanism for activating the operation of a trigger. A first idle driving preventive lever 17 is rotatable in a horizontal direction and capable of entering into and exiting form a fastener supply path 12 of a magazine. The contact mechanism includes a lower arm 21 which can be projected beyond a leading end of a nose part, an intermediate member 22 interlocking with the lower arm 21 and interlocking with the first idle driving preventive lever 17, and an upper arm 23 interlocking with a trigger. The intermediate member 22 includes a second idle driving preventive lever 32 which can engage with and disengage from the upper arm 23. The intermediate member 22 and lower arm 21 are urged downward. When the first idle driving preventive lever 17 enters into the magazine to rotate and the intermediate member 22 rotates, an engagement between a second idle driving preventive lever 32 and upper arm 23 is canceled.

### TECHNICAL FIELD

The present invention relates to a driving tool such as a nail driving tool and a screw driving tool. Specifically, the invention relates to a safety device, when it is used in such driving tool, not only can secure the safety of the driving tool but also can prevent the driving tool against idle driving.

### BACKGROUND ART

Generally, a driving tool is used to drive a faster such as a nail and a screw into wood or concrete. There is some driving tools including a contact mechanism for safety, and some driving tools which do not including the contact mechanism. The contact mechanism is used to activate a start operation of a trigger valve for starting the driving tool only when a contact member, which is relatively movable along a nose part having a fastener eject path, is pressed to a member to be fastener-driven. The contact member is normally urged by a spring such that it projects in a driving direction beyond a leading end of the nose part. In a fastener driving operation, when a leading end of the contact member is pressed to the member to be fastener-driven until the leading end of the nose part is butted to a driven portion of the member to be fastener-driven, the contact member is moved with respect to the nose part in an opposite direction to the pressing direction.

By a movement of the contact member, it is detected that the leading end of the nose part has been butted to the member to be fastener-driven, and an operation of a trigger can be activated.

On the other hand, there is also known an idle driving preventive mechanism which, regardless of provision of the contact mechanism, can prevent idle driving when connected nails stored within a magazine are consumed out and thus no connected nails are left in the inside of the magazine.

As disclosed in JP-A-2002-346950, in an idle driving preventive mechanism not including a contact member, an idle driving preventive lever is rotatable so as to enter into and exit from a magazine. When connected nails are present within the magazine, the idle driving preventive lever interlocks with an idle driving preventive arm. When a remaining number of the connected nails becomes small, the idle driving preventive lever rotates and thus, when a trigger is pulled, the idle driving lever is idly swung to thereby deactivate the operation of the trigger. At the time, no force is applied to the trigger.

In such idle driving preventive mechanism, since the nails can be detected directly, a tolerance accumulation of the composing parts of the idle driving preventive mechanism is small and thus a quality of the mechanism is stable. However, the safety of the driving tool cannot be secured.

On the other hand, a driving tool including a contact member can secure safety. However, in such driving tool, as disclosed in JP-A-2005-007546, when a pusher for feeding connected nails within a magazine toward the nose part side moves to a predetermined position of the magazine, an idle driving preventive lever is rotated to thereby lock a trigger. Since this is a mechanism in which, regardless of presence or absence of the connected nails, when the pusher advances to a predetermined position, the idle driving preventive lever is rotated, the tolerance accumulation of the composing parts of the mechanism is large and thus a wrong operation can occur, resulting in poor quality. When the pusher is operated wrong for one reason or for another, not only such wrong operation has an ill effect on the safety of the driving tool but also the trigger is locked; and thus, when the trigger is pulled forcibly, there is a fear that the trigger can be broken.

### DISCLOSURE OF THE INVENTION

One or more embodiments of the invention provides a driving tool which not only can prevent its idle driving operation but also can secure its safety.

According to one or more embodiments of the invention, a driving tool is provided with: a magazine for storing connected fasteners therein and capable of supplying the fasteners sequentially to a nose part disposed in a lower portion of a tool body; a striking mechanism for driving out a leading one of the fasteners within an eject path formed in the nose part according to an operation of a starting trigger; a contact mechanism which, when the lower end thereof is pressed to a member to be fastener-driven, can be moved along the eject path to thereby activate the operation of the trigger. A first idle driving preventive lever is disposed to be rotatable in a horizontal direction in such a manner that, when it is rotated, it can enter into and exit from a fastener supply path formed in the magazine. The contact mechanism includes a lower arm projectable beyond a leading end of the nose part, an intermediate member interlocking with the lower arm and interlocking with the first idle driving preventive lever, and an upper arm interlocking with the trigger. On the intermediate member, there is provided a second idle driving preventive lever which can be engaged with and disengaged from the upper arm. The intermediate member and lower arm are respectively urged downward. When the intermediate member rotates simultaneously when the first idle driving preventive lever moves into the magazine and rotates there, the engagement between the second idle driving preventive lever and the upper arm is canceled.

Also, according to one or more embodiments of the invention, the intermediate member and lower arm may also be coaxially supported.

According to one or more embodiments of the invention, when the connected fasteners are present within the magazine, the first idle driving preventive lever is pushed out of the magazine and is thereby prevented against rotation, that is, it cannot move into the fastener supply path and is thus left unrotatable. At the then time, since the second idle driving preventive lever is present at a position where it can be engaged with the upper arm, by pressing the lower arm against the member to be fastener-driven, the lower arm is moved upward with respect to the nose part and, at the same time, the intermediate member is moved upward; and, therefore, the second idle driving preventive lever pushes up the upper arm to thereby move it upward. This activates the operation of the trigger, thereby being able to start the driving operation of the driving tool.

On the other hand, when the remaining number of the connected fasteners becomes small and the last one of the fasteners moves beyond the leading end of the first idle driving preventive lever, the first idle driving preventive lever moves into the nose part. Owing to this, the second idle driving preventive lever, together with the intermediate member, is also rotated to move to a position where it is not engaged with the lower end of the upper arm. In this state, even when the leading end of the contact member is pressed against the member to be fastener-driven, the upper arm cannot be pushed upward. This deactivates the operation of the trigger, thereby preventing the driving tool from starting its driving operation.

As described above, the present mechanism is a mechanism which can detect the presence or absence of the connected fasteners within the nose part directly by the first idle driving preventive lever. Therefore, the present mechanism can prevent the idle driving operation of the driving tool. Also, since the contact mechanism incorporates therein an idle driving preventive function, the safety of the driving tool can also be secured.

Also, when the intermediate member and lower arm are supported coaxially, the relative movement of the lower arm, which is caused by pressing the lower arm against the member to be fastener-driven, can be transmitted directly to the intermediate member. This can facilitate their mutual linkage.

Other aspects and advantages of the invention will be apparent from the following description and the appended claims.

### BRIEF DESCRIPTION OF THE DRAWINGS

FIG. 1 is a perspective view of an example of a nail driving tool according to an exemplary embodiment of the invention.

FIG. 2 is a side view of the structure of the peripheral portion of a trigger valve used in the above nail driving tool.

FIG. 3 is a partially sectional view of a safety device used in the above nail driving tool, when viewed from the opposite side lateral surface thereof.

FIG. 4 is a section view of a shaft portion of the above nail driving tool.

FIG. 5A is a section view of a first idle driving preventive lever, showing a state in which it is not inserted into a magazine.

FIG. 5B is a section view of the first idle driving preventive lever, showing a state in which it is inserted into a magazine.

FIG. 6 is an enlarged view of the intermediate member and lower arm portion of the above nail driving tool.

FIG. 7 is a transverse section view of a leading end portion of a nose part of the above nail driving tool.

FIG. 8 is an explanatory view of engagement between an upper arm and first and second contact levers.

FIG. 9 is an explanatory view of a state in which, while connected nails are loaded in a magazine, a trigger is operated or pulled with a contact arm not pressed against a member to be nail-driven.

FIG. 10 is an explanatory view of a state in which the trigger is operated or pulled correctly.

FIG. 11 is an explanatory view of a state in which the trigger is pulled while no connected nails are present within the magazine.

### DESCRIPTION OF REFERENCE NUMERALS

1: Nail driving machine
5: Magazine
10: Trigger
12: Nail supply path
13: Trigger valve stem
17: First idle driving preventive lever
21: Lower arm
23: Upper arm
32: Second idle driving preventive lever

### BEST MODE FOR CARRYING OUT THE INVENTION

Now, description will be given below of an exemplary embodiment of the invention.

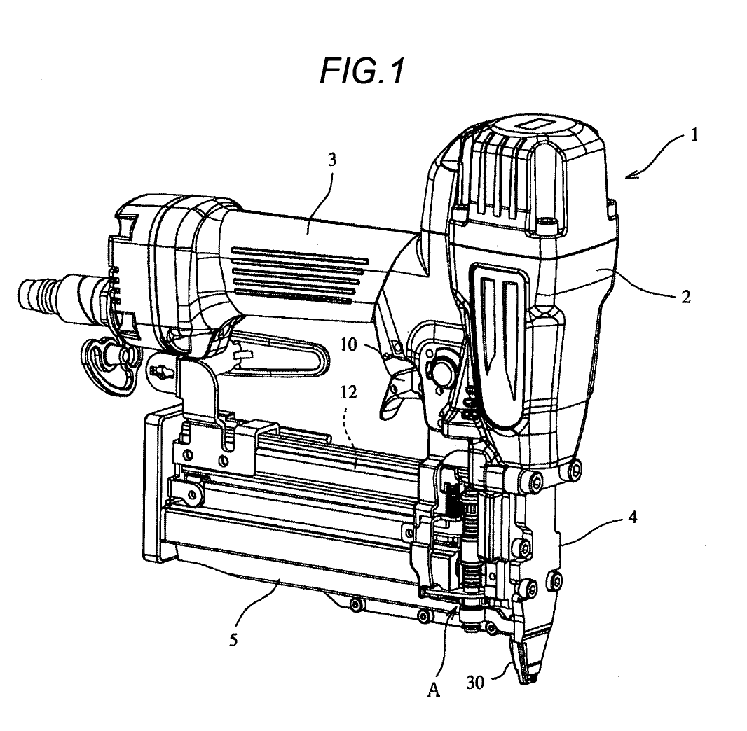

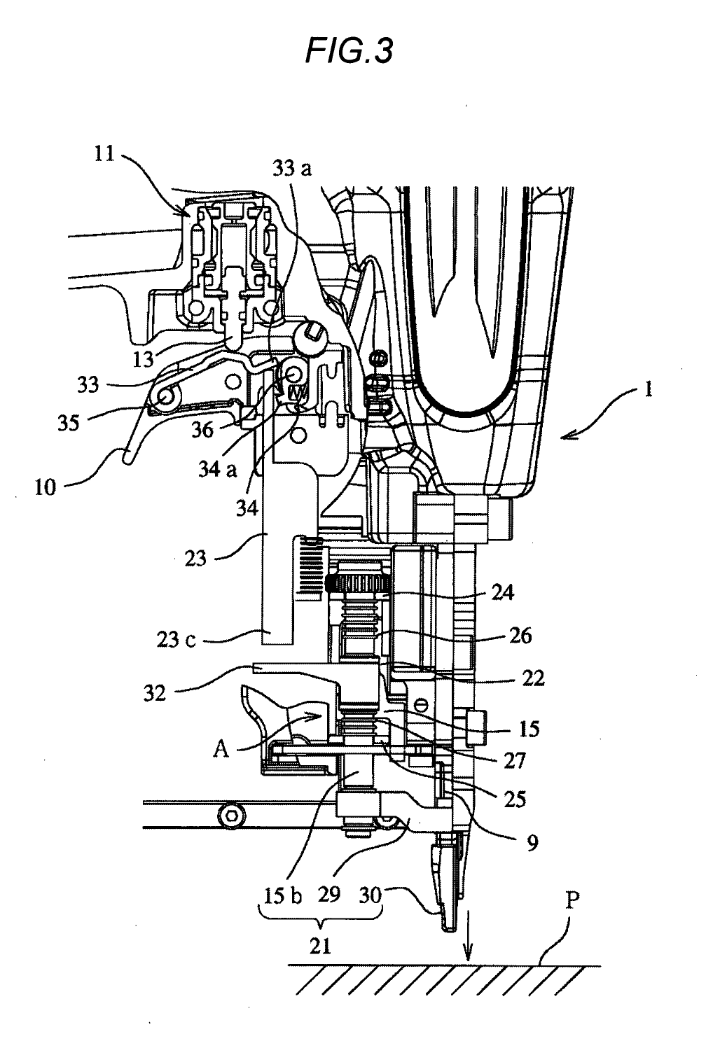

In FIGS. 1 to 3, reference numeral 1 designates a nail driving tool. This nail driving tool 1 includes a tool body 2 having a striking mechanism, a grip 3 disposed rearward of the tool main body 2, a nose part 4 disposed on the lower end of the tool body 2, and a rectangular-shaped magazine 5 for supplying connected nails (pin nails) to the nose part 4, in which the leading nail of the connected nails supplied to an eject path 7 formed in the nose part 4 is driven out from the nose part 4 using a driver 6 constituting the above-mentioned striking mechanism. Here, the eject path 7 is formed between a driver guide 8 constituting the front wall of the nose part 4 and a wear plate 9 constituting the rear wall of the nose part 4.

To drive out a nail, a trigger 10 is pulled to operate a trigger valve 11, whereby compressed air supplied from an air compressor is fed to the striking mechanism and the above-mentioned leading nail is driven out using the pressure of the compressed air. The trigger valve 11 for starting the nail driving operation is the same as a conventionally known trigger valve. Specifically, when the compressed air is supplied from the air compressor to the trigger valve 11, the trigger valve 11 pushes out a valve stem 13 downward and this valve stem 13 is then pushed in upward by the trigger 10 to thereby start the driving operation.

By the way, in relation to the pulling operation of the trigger 10, there is provided a safety device A which includes: a contact mechanism which, only when a sufficient number of nails are stored within the nail supply path 12 of the magazine 5 and a contact arm (which will be discussed later) is actually pressed against a member to be nail-driven, can operate the trigger valve 11 effectively; and, an idle driving preventive mechanism which, when a sufficient number of nails are not present within the magazine 5, can prevent the trigger valve 11 against operation.

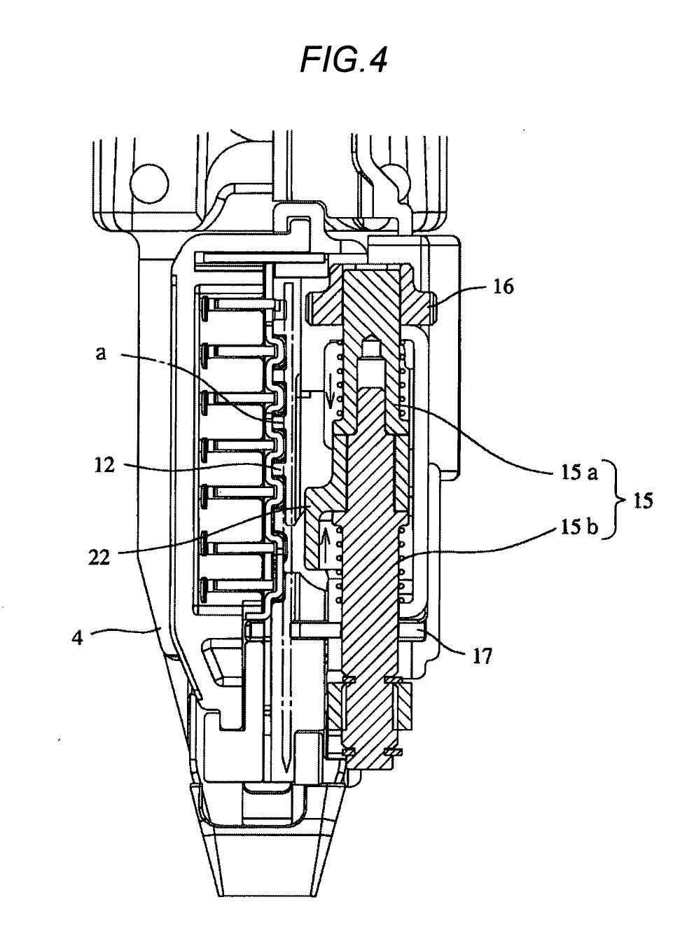

That is, backwardly of the nose part 4, there is disposed a shaft member 15 which can be moved in the vertical direction parallel to the axis of the eject path 7 of the nose part 4. As shown in FIG. 4, the shaft member 15 is a unified body of an upper shaft member 15a and a lower shaft member 15b, while the lower shaft member 15b is formed such that it is prevented from rotating with respect to the upper shaft member 15a. Also, with the upper portion of the upper shaft member 15a, there is threadedly engaged an adjust dial 16; and, by rotating the adjust dial 16, the vertical position of a connecting arm 29 can be adjusted.

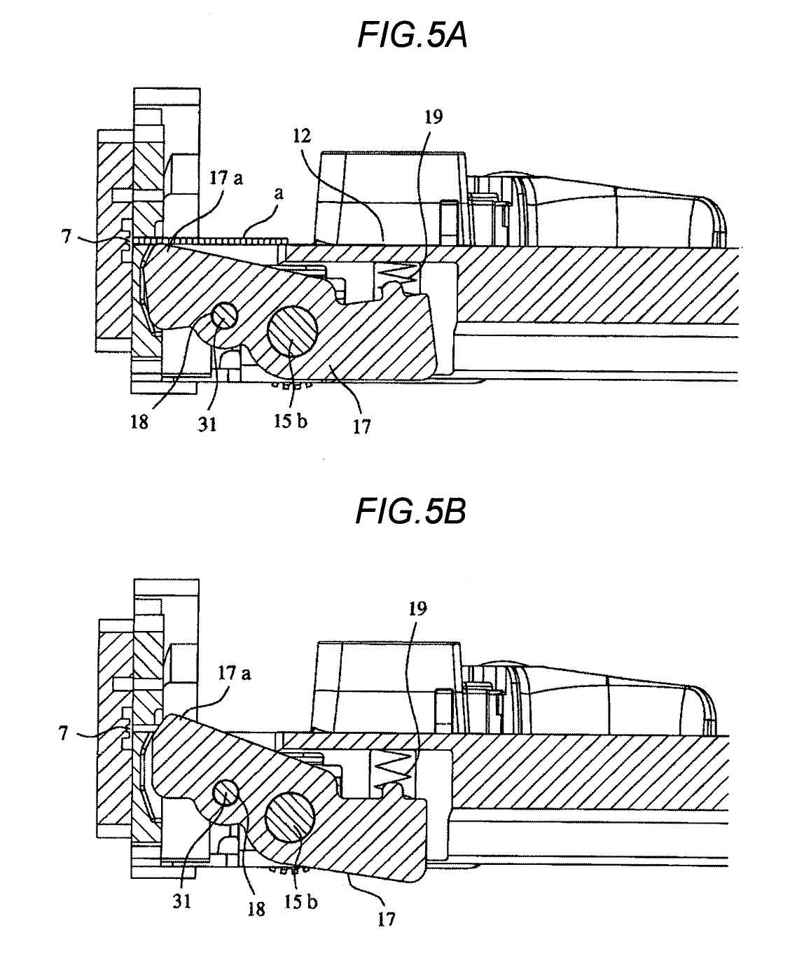

And, on the lower shaft member 15b, there is supported the intermediate barrel portion of a first idle driving preventive lever 17 in such a manner that it can be rotated in the horizontal direction perpendicular to the nail driving direction. The first idle driving preventive lever 17 is structured such that, as shown in FIGS. 5A and 5B, one end portion 17 thereof can enter into and exit from the inside of the magazine 5 when the first idle driving preventive lever 17 is rotated, while in the other portion of the lever 17, there is formed a penetration hole 18. Also, the first idle driving preventive lever 17 is urged by a spring 19 in such a manner that the above-mentioned one end portion 17a can move into the nail supply path 12; and, when the end portion 17a is engaged with the connected nails a, the first idle driving preventive lever 17 is pushed out of the magazine 5 against the urging force of the spring 19. And, the first idle driving preventive lever 17 is fitted with the shaft member 15 such that it is rotatable with respect to the shaft member 15, while the lever 17 itself does not move up and down but is always held at a constant position in the vertical direction.

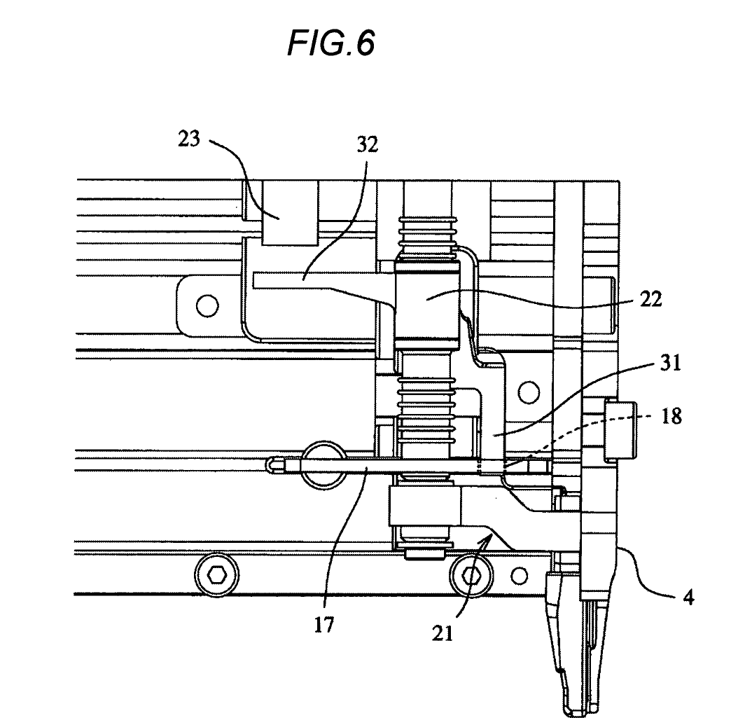

Also, the contact mechanism, as shown in FIG. 6, includes a lower arm 21 which can be projected beyond the leading end of the nose part 4, an intermediate member 22 which is interlocking with the lower arm 21 and interlocking with the first idle driving preventive lever 17, and an upper arm 23 interlocking with the trigger 10.

Referring here to the magazine 5, at the positions thereof that respectively correspond to the upper and lower portions of the shaft member 15, there are formed spring receive portions 24 and 25; and, between the respective spring receive portions 24, 25 and the above-mentioned intermediate member 22, there are interposed upper and lower springs 26 and 27, respectively.

The lower arm 21 is composed of the lower shaft member 15b, a connecting arm 29 bent from its lower end toward the nose part 4, and a contact portion 30 formed so as to extend downward from the leading end of the connecting arm 29. The lower spring 27 is wound on the lower shaft member 15b. The contact portion 30 is disposed such that it can be moved along the wear plate 9 of the nose part 4.

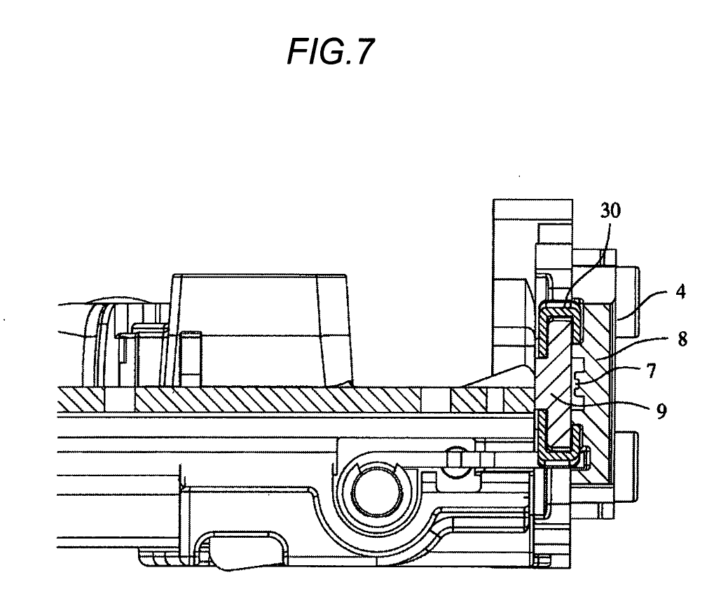

The lower arm 21, together with the intermediate member 22, is held between the upper and lower springs 26 and 27 and is urged by the upper spring 26 in such a manner that the contact portion 30 is projected slightly beyond the nose part 4. Here, the contact portion 30, as shown in FIG. 7, is formed separately from the wear plate 9 and is disposed such that it can be moved up and down along the rear surface of the wear plate 9.

The intermediate member 22 is disposed so as to interlock with the first idle driving preventive lever 17 in the horizontal direction and interlock with the lower arm 21 in the vertical direction. That is, the intermediate member 22 is rotatably supported between the upper and lower shaft members 15a and 15b. On one portion of the intermediate member 22, there is provided an inverted L-shaped connecting rod 31 such that it projects therefrom and, on the other portion thereof, there is projectingly provided a second idle driving preventive lever 32. The lower end of the connecting rod 31 is slidably inserted into the penetration hole 18 of the first idle driving preventive lever 17 and, even when the intermediate member 22 is moved in the vertical direction, the engaged state thereof can be held. Thanks to this, when the first idle driving preventive lever 17 is rotated in the horizontal direction, the intermediate member 22 is rotated in linking with this and, at the same time, the second idle driving preventive lever 32 is also rotated. Also, when the lower arm 21 is moved up and down, the intermediate member 22 is also moved up and down in linking with this.

The second idle driving preventive lever 32 is disposed such that it can be engaged with and disengaged from the lower end of the upper arm 23. That is, in a state where the first idle driving preventive lever 17 is not present in the inside of the magazine 5 (in a state shown in FIG. 5A), the second idle driving preventive lever 32 is present at a position where it can be engaged with the lower end 23c of the upper arm 23; and, when the first idle driving preventive lever 17 has entered the magazine 5 (in a state shown in FIG. 5B), the second idle driving preventive lever 32 is rotated to a position where it is prevented from being engaged with the lower end 23c of the upper arm 23.

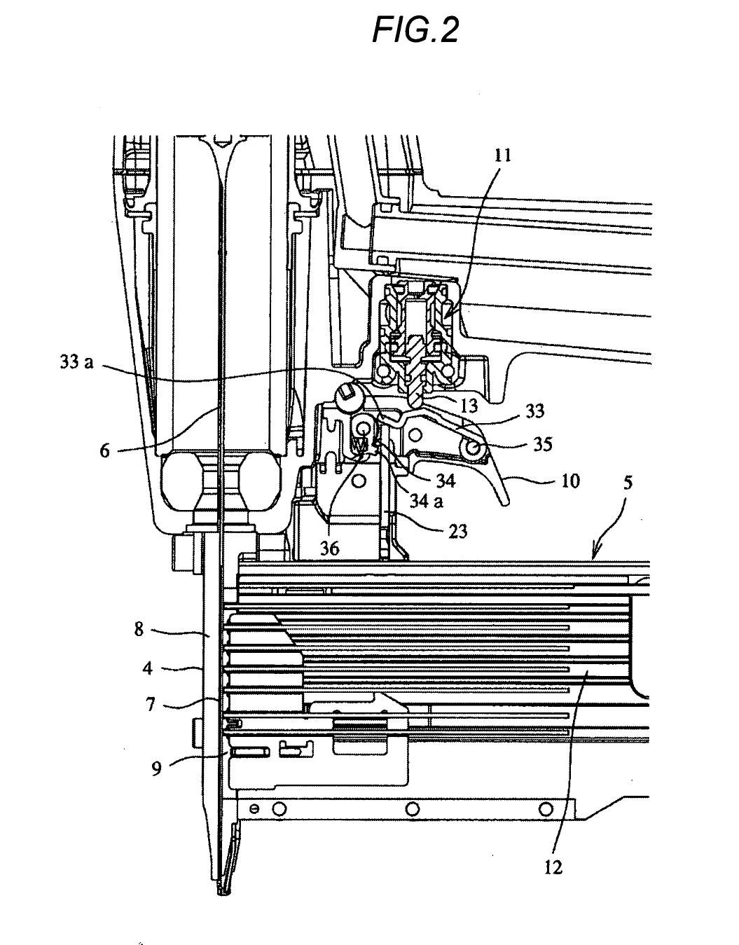

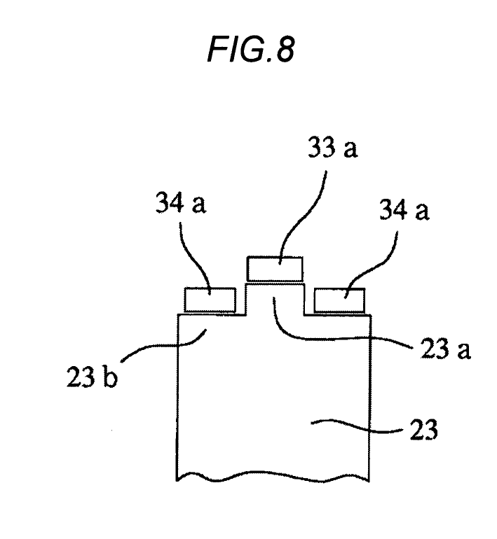

Next, as shown in FIG. 2, the upper arm 23 is disposed downwardly of the trigger 10 such that it can be moved up and down. In the inside of the trigger 10, there are disposed first and second contact levers 33 and 34 in such a manner that they can be rotated about their respective support shafts 35 and 36 respectively. The upper arm 23 is interposed between the first and second contact levers 33 and 34. The upper end of the upper arm 23 is formed such that the central portion 23a thereof is higher than the two side portions thereof. As shown in FIG. 8, the leading end portion 33a of the first contact lever 33 is formed such that it can be engaged with the central portion 23a, whereas the leading end portions 34a of the second contact lever 34 are formed so as to be engageable with the two shoulder portions 23b of the upper arm 23 respectively. Also, the upper arm 23 is normally urged upwardly by a spring 37.

According to the above structure, the lower arm 21 and intermediate member 22 are respectively held between the upper and lower springs 26 and 27 in such a manner that they can be moved upward against the urging force of the upper spring 26 and can be moved downward against the urging force of the lower spring 27. The stroke of the lower arm 21 and intermediate member 22 from the above-mentioned stop position to the lower moving end thereof is set about half the stroke of a conventional contact arm.

Here, the middle portion of the first contact lever 33 is situated downwardly of the valve stem 13 of the trigger valve 11 for starting the nail driving operation, whereas the second contact lever 34 is urged by a spring 38 such that, when the trigger 10 is pulled, the second contact lever 34 can be projected upwardly of the upper arm 23 in linking with the pulling operation of the trigger 10.

Next, description will be given below of the operation of the safety device of the nail driving tool structured in the above-mentioned manner. Normally, the contact portion 30 of the leading end of the contact arm is projected downwardly of the nose part 4 by the upper spring 26. Also, when a sufficient number of nails are present within the nail supply path 7 of the magazine 5, the first idle driving preventive lever 17 is pushed out of the magazine 5, whereby the second idle driving preventive lever 32 is present at a position where it can be engaged with the lower end of the upper arm 23.

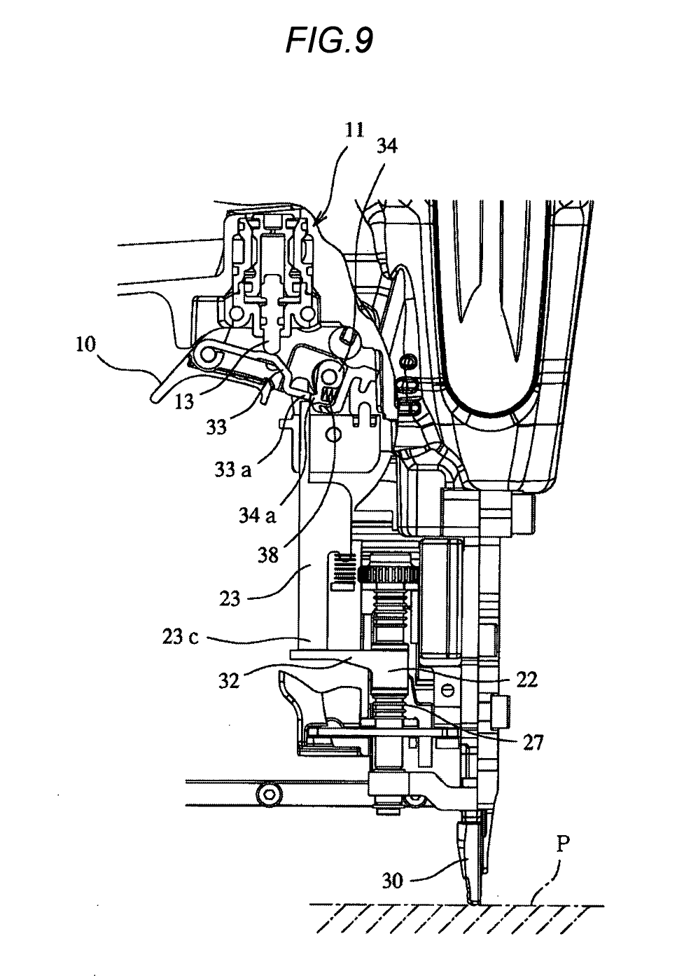

In this state where the valve stem 13 of the trigger valve 11 is pushed out downwardly by the compressed air, when the trigger 10 is pulled up, as shown in FIG. 9, the first contact lever 33 is swung with its engaged portion with the valve stem 13 as a fulcrum thereof and thus the leading end 33a thereof pushes down the upper arm 23 against the urging force of the spring 37. Since the lower end 23c of the upper arm 23 is engaged with the second idle driving preventive lever 32, the shaft member 15 and contact portion 30, together with the intermediate member 22, are also projected further downward against the urging force of the lower spring 27. This prevents the nail driving tool from starting its operation.

Also, when the trigger 10 is pulled up in this manner, as described above, the upper arm 23 is moved downward, so that, simultaneously with the downward movement of the upper arm 23, the second contact lever 34 is rotated and projected upwardly of the upper arm 23. Even when the contact portion 30 of the lower arm 21 is thereafter pressed against the member to be nail-driven P, as shown in FIG. 8, the leading end 34a of the second contact lever 34 is engaged with the shoulder portion 23b of the upper end of the upper arm 23 to thereby prevent the upper arm 23 from moving upward. This makes it impossible for the first contact lever 33 to push up the valve stem 13. That is, the above-mentioned operation of the trigger 10 is deactivated. In other words, when the contact portion 30 is pressed against the member to be nail-driven P, the lower arm 2l, intermediate member 22 and second idle driving preventive lever 32 are respectively moved upward against the urging force of the upper spring 26 to thereby try to move the upper arm 23 further upward. However, since the shoulder portion 23b of the upper end of the upper arm 23 is engaged with the leading end 34a of the second contact lever 34, the upward movement of the upper arm 23 is prevented. Owing to this, even when the trigger 10 is pulled, the first contact lever 33 cannot be moved up so sufficiently as to be able to push in the valve stem 13 of the trigger valve 11, thereby preventing the nail driving tool from starting its operation. Therefore, it is impossible to carry out a so called contact driving operation in which, in a state where the trigger 10 is pulled, the leading end of the contact portion 30 is pressed against the member to be nail-driven P to start the driving operation.

By the way, without the second contact lever 34, the contact driving operation can be carried out.

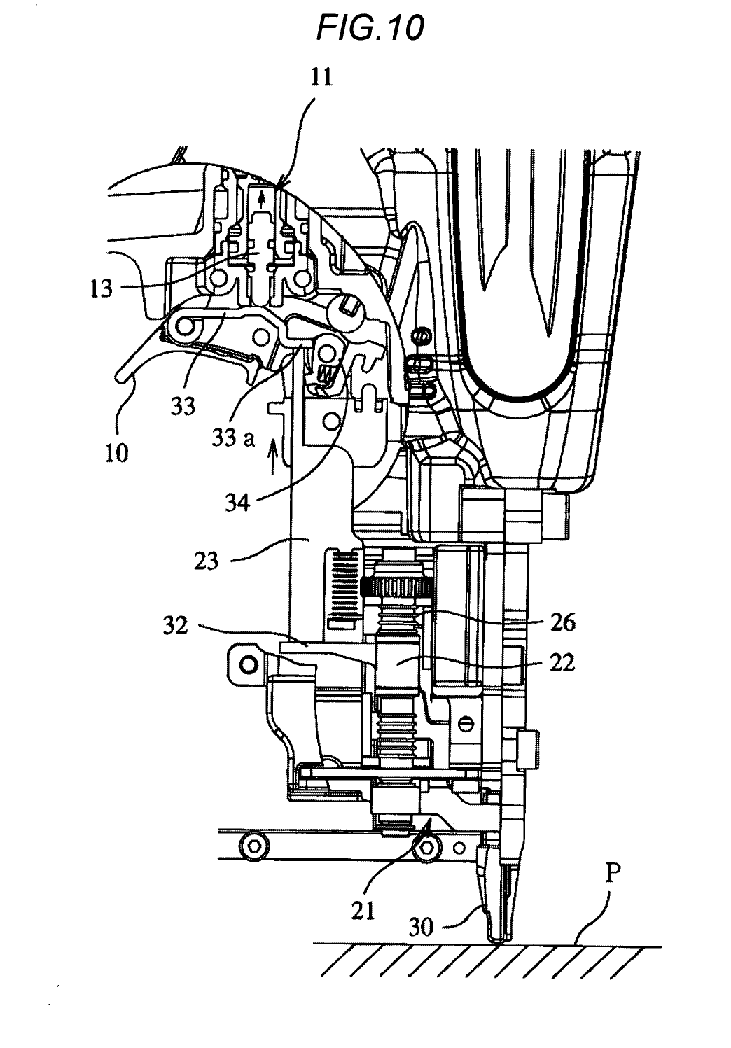

To drive a nail correctly, as shown in FIG. 10, firstly, the contact portion 30 of the lower arm 21 is pressed against the member to be nail-driven P. As a result of this, with respect to this pressing operation, the lower arm 21, together with the intermediate member 22, is moved upward against the urging force of the upper spring 26, so that the second idle driving preventive lever 32 of the intermediate member 22 is moved just below the upper arm 23. In this state, when the trigger 10 is pulled, the first contact lever 33 is swung with its engaged portion with the valve stem 13 of the trigger valve 11 as a fulcrum thereof, while the leading end 33a of the first contact lever 33 moves the upper arm 23 downward against the urging force of the spring 37. However, the lower end 23c of the upper arm 23 is engaged with the second idle driving preventive lever 32 and is thereby prevented from moving down any further. Owing to this, since the first contact lever 33 is rotated with the its engaged portion with the upper end of the upper arm 23 as a fulcrum thereof, the middle portion of the contact lever 33 can push in the valve stem 13 upwardly to thereby actuate the trigger valve 11, which can start the operation of the nail driving tool.

By the way, when the trigger 10 is pulled up after the upper arm 23 moves upward, the upper arm 23 prevents the second contact lever 34 from projecting upwardly of the upper arm 23.

Use of the above-mentioned contact mechanism can secure the safety of the nail driving tool.

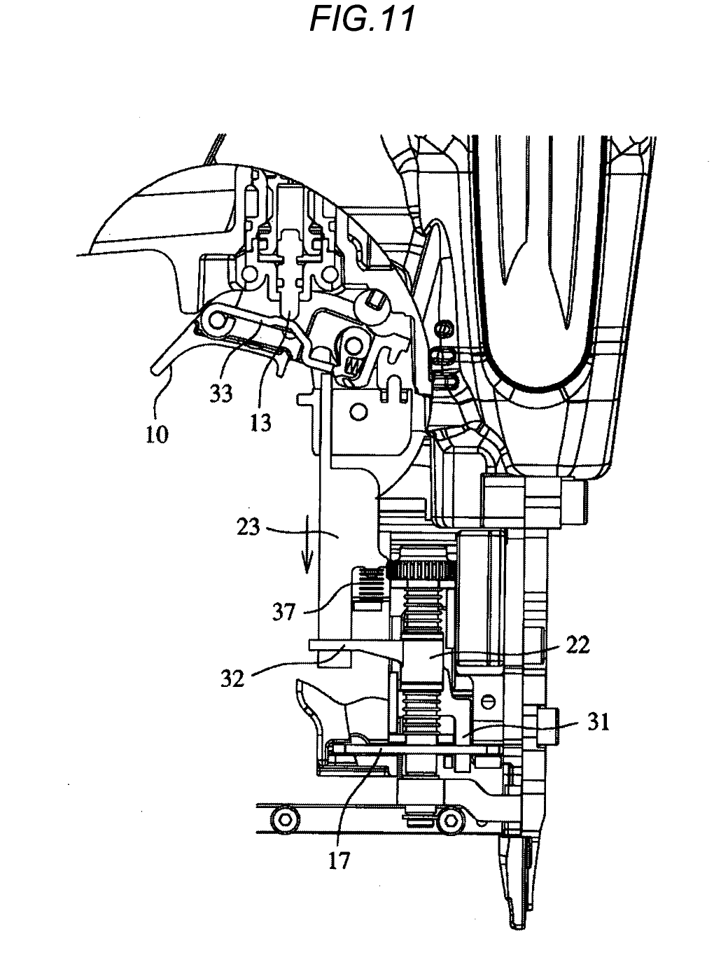

Now, when the remaining number of connected nails within the magazine 5 is small and the last nail moves beyond the leading end 18a of the first idle driving preventive lever 17, as shown in FIG. 5B, the first idle driving preventive lever 17 moves into the nail supply path 12 of the nose part 4 and the intermediate member 22 rotates, whereby the second idle driving preventive lever 32 is also rotated by the connecting rod 31 and is thus moved to a position where it is prevented from being engaged with the lower end of the upper arm 23. In this state, even when the contact portion 30 is pressed against the member to be nail-driven P, the second idle driving preventive lever 32, together with the intermediate member 22, is moved upward but is not engaged with the upper arm 23. Therefore, when the trigger 10 is pulled in this state, as shown in FIG. 11, the first contact lever 33 is rotated with its engaged portion with the valve stem 13 of the trigger valve 11 as a fulcrum thereof, while the leading end of the first contact lever 33 is butted against the upper arm 23 to move the upper arm 23 downward against the urging force of the spring 37. Since the upper arm 23 is not engaged with the second idle driving preventive lever 32, the upper arm 23 is moved downward as it is and is thereby swung idle. Owing to this, the first contact lever 33 is also unable to push in the valve stem 13. Therefore, the nail driving tool cannot be started, which can prevent the idle driving operation of the nail driving tool effectively.

As described above, since the present mechanism is a mechanism which can detect the presence or absence of the connected nails within the nose part 4 directly by the first idle driving preventive lever 17, the idle driving operation of the nail driving tool can be prevented positively.

Because the present contact mechanism incorporates therein the above-mentioned idle driving preventive function, it can secure the safety of the nail driving tool as well.

As described above, since the lower arm 21 constituting the contact mechanism is held between the two upper and lower springs 26 and 27, not only the lower arm 21 itself has cushioning characteristics but also the stroke of the lower arm 21 in the actual nail driving operation can be set short; and, therefore, it is easy to control a force used to press the contact portion 30 of the lower arm 21 against the member to be nail-driven P. Also, firstly because the stroke of the lower arm 21 is small, secondly because the contact portion 30 of the lower arm 21 is provided independent of the eject path 7 of the nose part 4 and is thus prevented from meshing with other members or nails while the lower arm 21 is moving in the vertical direction, whereby the lower arm 21 can be moved smoothly, and thirdly because the lower arm 21 is simple in structure and light in weight, the spring load of the upper spring 26 can be set small. Therefore, also when driving a nail into a member to be nail-driven made of soft material, the lower arm 21 may be pressed against the member to be nail-driven with a small force, which can prevent the member to be nail-driven against damage or generation of a dent.

Also, when the stroke of the contact mechanism is long, the spring load must be large, so that the pressing force is inevitably increased. Owing to this, when the leading end of the nose part 4 is butted against the surface of the member to be nail-driven, the impact thereof is strong. On the other hand, according to the present contact mechanism, since the stroke is short and the spring load of the upper spring 26 is small, it is easy to control a force used when pressing the lower arm 21 against the member to be nail-driven, thereby being able to enhance the operation efficiency of the nail driving tool.

According to the above embodiment, although the contact mechanism has been described with reference to the contact arm which is provided separately from the nose part, it is also possible to use a contact nose the leading end of which plays the role of a contact.

Also, the present invention is not limited to a nail driving tool. But, the invention can also be applied not only to a nail driving tool and a pneumatic tool but also to a driving tool which can be driven by electric power.

Although the invention has been described heretofore with reference to its specific embodiment, it is obvious to a person skilled in the arm that various changes and modifications are also possible without departing from the spirit and scope of the invention.

The present application is based on the Japanese Patent Application (Patent Application 2005-152035) filed on May 25, 2005 and thus the contents thereof are incorporated herein for reference.

### INDUSTRIAL APPLICABILITY

The invention can be applied to a safety device for use in a driving tool such as a nail driving tool and a screw driving tool to secure the safety of the driving tool and prevent the idle driving operation thereof.

1. A driving tool comprising:
a magazine for storing connected fasteners therein and capable of sequentially supplying the fasteners to a nose part disposed in a lower portion of a tool body;
a striking mechanism for driving out a leading one of the fasteners within an eject path in the nose part according to an operation of a starting trigger;
a contact mechanism that is movable along the eject path by pressing a lower end of the contact mechanism to a member to be fastener-driven and activates the operation of the trigger; and
a first idle driving preventive lever rotatable in a horizontal direction and capable of entering into and exiting from the a fastener supply path of the magazine,
wherein the contact mechanism includes:
a lower arm projectable beyond a leading end of the nose part;
an intermediate member interlocking with the lower arm and interlocking with the first idle driving preventive lever; and
an upper arm interlocking with the trigger,
wherein the intermediate member includes a second idle driving preventive lever capable of engaging with and disengaging from the upper arm,
wherein the intermediate member and lower arm are urged downward, and
when the first idle driving preventive lever enters into the fastener supply path to rotate and the intermediate member rotates, the second idle driving preventive lever and the upper arm are disengaged.

2. The driving tool according to claim 1, wherein the intermediate member and lower arm are coaxially supported.
